(19) United States
(12) Patent Application Publication
(10) Pub. No.: US 2024/0056266 A1
(43) Pub. Date: Feb. 15, 2024

(54) FEMTOCELL BASE STATION OF SPECIALIZED NETWORK AND SYNCHRONIZATION METHOD THEREOF

(71) Applicant: KT CORPORATION, Gyeonggi-do (KR)

(72) Inventor: Byung-Wan YOON, Gyeonggi-do (KR)

(73) Assignee: KT CORPORATION, Gyeonggi-do (KR)

(21) Appl. No.: 18/231,441

(22) Filed: Aug. 8, 2023

(30) Foreign Application Priority Data
Aug. 11, 2022 (KR) 10-2022-0100737

(51) Int. Cl. H04L 5/00; H04L 5/14

(52) U.S. Cl. CPC H04L 5/0078; H04L 5/14; H04L 5/0048

(57) ABSTRACT

A synchronization method of a femtocell base station built in a specialized network includes searching for at least one neighboring base station by scanning signals in a second frequency band different from a first frequency band allocated for the specialized network, determining a reference base station for synchronization from among the at least one neighboring base station, analyzing the signal transmitted from the reference base station to detect start timing of a time division duplex (TDD) radio frame, and finely adjusting the start timing using a delay time corresponding to a distance from the reference base station.

### CROSS-REFERENCE TO RELATED APPLICATION

This application claims priority to and the benefit of Korean Patent Application No. 10-2022-0100737 filed in the Korean Intellectual Property Office on Aug. 11, 2022, the entire contents of which are incorporated herein by reference.

### BACKGROUND

### (a) Field

The present disclosure relates to a specialized network.

### (b) Description of the Related Art

A mobile communication base station needs to provide communication services by ensuring synchronization accuracy for time and frequency. The synchronization accuracy that needs to be secured is defined in the standard, and various technologies are used to secure the synchronization accuracy of the mobile communication base station.

In the case of a macro cell, the synchronization signal generated by the grand master node is delivered to a central unit/digital unit (CU/DU) concentrated at an edge center, and is transmitted to a plurality of radio units (RUs) connected to the CU/DU. In this way, all the RUs may transmit synchronized radio frames.

In this case, in the case of a macro cell built by a mobile communication service provider, since devices are connected through a private line, the number of hops from the grand master node to the slave node (CU/DU/RU) may be reduced, so the mobile communication base station may improve synchronization accuracy. However, when devices are connected using a general Internet network rather than the private line, the number of hops from the grand master node to the slave node increases, which may reduce the synchronization accuracy.

### SUMMARY

The present disclosure provides a femtocell base station of a specialized network and a synchronization method thereof.

The present disclosure provides a method for a femtocell base station built for a specialized network service to obtain TDD synchronization information using signals from neighboring base stations using different frequency bands.

The present disclosure provides a method for a femtocell base station built for a specialized network service to acquire synchronization information by analyzing a signal from a reference base station, and to finely adjust start timing of a TDD radio frame by reflecting a delay time according to a distance from the reference base station.

According to an embodiment, a synchronization method of a femtocell base station built in a specialized network comprises searching for at least one neighboring base station by scanning a signal in a second frequency band different from a first frequency band allocated for the specialized network, determining a reference base station for synchronization from among the at least one neighboring base station, analyzing the signal transmitted from the reference base station to detect start timing of a time division duplex (TDD) radio frame, and finely adjusting the start timing using a delay time corresponding to a distance from the reference base station.

The determining the reference base station may comprise determining the reference base station from among the at least one neighboring base station based on reference signal received power.

The finely adjusting the start timing may comprise estimating the distance from the reference base station based on transmitted power and received power of the reference signal transmitted from the reference base station, and finely adjusting the start timing using the delay time corresponding to the distance.

The finely adjusting the start timing may comprise: initially adjusting the start timing based on random transmitted power and the received power, when the transmitted power of the reference signal is not detected; and readjusting the start timing based on the detected transmitted power and received power, when the transmitted power of the reference signal is detected.

The synchronization method may further comprise: providing the specialized network service using the TDD radio frame synchronized to the reference base station by the finely adjusted start timing.

The reference base station may comprise a macrocell base station that provides a communication service in the second frequency band.

The synchronization method may further comprise: when the neighboring base station is not searched through the scanning in the second frequency band, searching for at least one new neighboring base station by scanning the signals in the first frequency band and determining the reference base station from among the at least one new neighboring base station.

The synchronization method may further comprise: when the reference base station is searched in the first frequency band, determining whether the reference base station belongs to the same group to use the same TDD configuration as the reference base station or use a TDD configuration different from the reference base station.

The femtocell base station may be an all-in one base station including a central unit (CU), a digital unit (DU), and a radio unit (RU).

According to another embodiment, a synchronization method of a femtocell base station built in a specialized network comprises: determining a reference base station for synchronization from among the searched neighboring base stations; analyzing the signal transmitted from the reference base station to determine start timing of a TDD radio frame; and providing the specialized network service using the TDD radio frame synchronized to the reference base station by the determined start timing.

The determining the reference base station may comprise determining the reference base station from among the at least one neighboring base station based on reference signal received power.

The reference base station may comprise a neighboring macrocell base station that provides a communication service using a second frequency different from a first frequency allocated for the specialized network, or a neighboring femtocell base station that provides a specialized network service using the first frequency.

The synchronization method may further comprise: when the reference base station is the neighboring femtocell base station, determining whether the reference base station belongs to the same group; when the reference base station belongs to the same group, configuring a TDD radio frame with the same TDD configuration as the reference base station; and when the reference base station belongs to a different group, configuring the TDD radio frame with a TDD configuration different from the reference base station.

The determining the start timing may comprise: analyzing a signal transmitted from the reference base station to detect the start timing, and estimating the distance from the reference base station based on transmitted power and received power of the reference signal transmitted from the reference base station, and finely adjusting the start timing using the delay time corresponding to the distance.

The finely adjusting the start timing may comprise: initially adjusting the start timing based on random transmitted power and the received power, when the transmitted power of the reference signal is not detected: and readjusting the start timing based on the detected transmitted power and received power, when the transmitted power of the reference signal is detected.

The femtocell base station may be an all-in one base station including a central unit (CU), a digital unit (DU), and a radio unit (RU).

According to still another embodiment, a femtocell base station for a specialized network comprises: a central unit (CU), a digital unit (DU), a radio unit (RU), and synchronization detection module. The synchronization detection module may be configured to search for at least one neighboring base station by scanning signals in a second frequency band different from a first frequency band allocated for the specialized network, determine a reference base station for synchronization from among the at least one neighboring base station, detect start timing of a time division duplex (TDD) radio frame by analyzing a signal transmitted from the reference base station, and then, acquire synchronization information by finely adjusting the start timing using a delay time corresponding to a distance from the reference base station.

The synchronization detection module may be configured to estimate the distance from the reference base station based on transmitted power and received power of the reference signal transmitted from the reference base station, and finely adjust the start timing using the delay time corresponding to the distance.

The synchronization detection module may be configured to search for at least one new neighboring base station by scanning the signals in the first frequency band and determine the reference base station from among the at least one new neighboring base station, when the neighboring base station is not searched through the scanning in the second frequency band.

The synchronization detection module may be configured to determine whether the reference base station belongs to the same group to use the same TDD configuration as the reference base station or use a TDD configuration different from the reference base station, when the reference base station is searched in the first frequency band.

According to the present disclosure, it is possible for a femtocell base station built for a specialized network service to analyze signals from neighboring base stations and acquire synchronization information without the need to build a separate grand master node for the specialized network.

According to the present disclosure, it is possible to increase synchronization accuracy by finely adjusting start timing of a TDD radio frame using a delay time corresponding to a distance from a reference base station.

According to the present disclosure, even if a femtocell base station built for a specialized network service does not discover a macrocell base station using a public frequency, it is possible to obtain synchronization information by analyzing signals from neighboring femtocell base stations using a private frequency.

### BRIEF DESCRIPTION OF THE DRAWINGS

FIG. 1 is an example of a TDD radio frame.

FIG. 2 is a diagram for describing a signal synchronization method in a macrocell.

FIG. 3 is an exemplary diagram for describing an environment in which a femtocell base station is built for a specialized network service according to an embodiment of the present disclosure.

FIG. 4 is a flowchart of a synchronization method of a femtocell base station for a specialized network service according to embodiments of the present disclosure.

FIG. 5 is a flowchart of a synchronization method of a femtocell base station for a specialized network service according to embodiments of the present disclosure.

FIG. 6 is a schematic diagram of a femtocell base station for a specialized network service according to an embodiment of the present disclosure.

### DETAILED DESCRIPTION OF THE EMBODIMENTS

Hereinafter, exemplary embodiments of the present disclosure will be described in detail with reference to the accompanying drawings so that those skilled in the art to which the present disclosure pertains may easily practice the present disclosure. However, the present disclosure may be modified in various different forms, and is not limited to embodiments provided in the present specification. In addition, components unrelated to a description will be omitted in the accompanying drawings in order to clearly describe the present disclosure, and similar reference numerals will be used to denote similar components throughout the present specification.

Throughout the specification, unless explicitly described to the contrary, the word “comprise” and variations such as “comprises” or “comprising”, will be understood to imply the inclusion of stated elements but not the exclusion of any other elements.

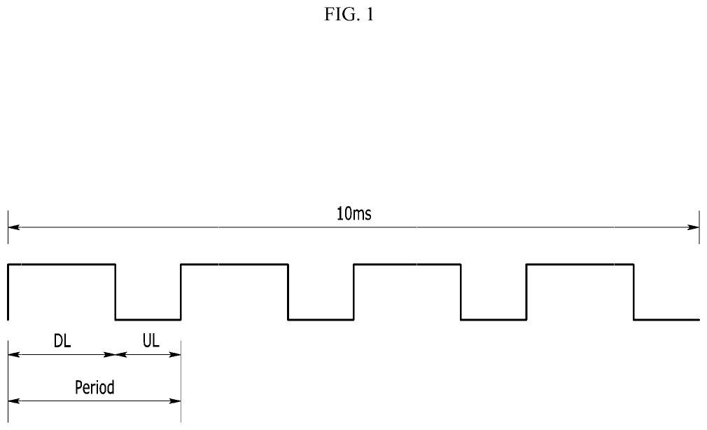

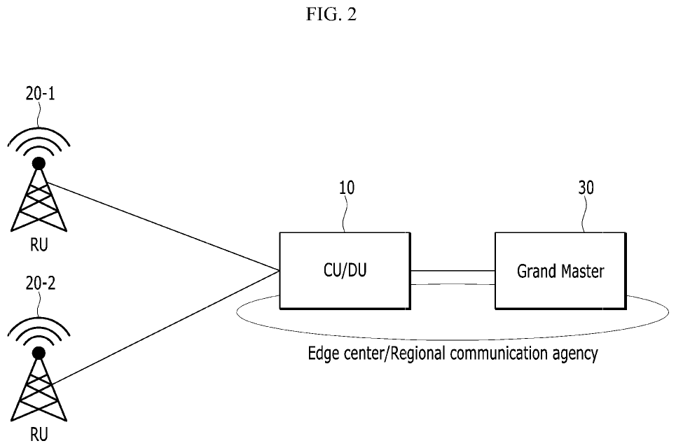

FIG. 1 is an example of a TDD radio frame. FIG. 2 is a diagram for describing a signal synchronization method in a macrocell.

Referring to FIG. 1, a time division duplex (TDD) communication device transmits and receives data by time dividing a radio frame into a downlink DL and an uplink UL. In the case of the TDD communication devices, it is possible to improve communication quality only by transmitting a DL signal and a UL signal while switching between a DL section and a UL section according to a reference clock. When the TDD communication devices transmit the DL signal and the UL signal at different timings, mutual interference may occur and thus performance may deteriorate. Typically, the TDD communication device may be synchronized using GPS information and the IEEE 1588 Precision Time Protocol (PTP).

Referring to FIG. 2, a macrocell may mainly include a central unit (CU)/digital unit (DU) 10 concentrated at an edge center, and a plurality of radio units (RUs) 20-1, 20-2, . . . , connected to the CU/DU 10. In this way, when a network is implemented in a distributed structure in which multiple RUs 20-1, 20-2, . . . , are physically connected to one DU 10, a grand master node 30 may be used to synchronize the devices.

A clock of the grand master node 30 is used as a reference clock, and clocks of slave nodes are synchronized to the reference clock. To this end, when the grand master node 30 generates a synchronization signal with information received from a GPS receiver and transmits the synchronization signal to the CU/DU 10 that is the slave node, the synchronization signal is transmitted to the RUs 20-1 and 20-2, so the RUs 20-1 and 20-2 transmit the synchronized TDD wireless frame. Each RU may install the GPS receiver to individually acquire synchronization information, but the synchronization method using the grand master node is mainly used because it is economical.

Meanwhile, the synchronization accuracy is affected by the number of hops from the grand master node, which is the reference clock, to the slave node. Therefore, in the case of a macrocell built by a mobile communication service provider by connecting devices with a private line, the network may be designed considering the number of hops, thereby ensuring the synchronization accuracy. However, when the grand master node and the slave nodes are connected through a general Internet network, the number of hops increases, so the synchronization accuracy may decrease.

Meanwhile, a mobile network operator (MNO) may provide communication services by being allocated a public frequency (for example, a frequency in the 3.5 GHz band in Korea) and establishing a public network. Recently, specialized networks allowing specialized network providers to provide specialized services to specific spaces such as buildings and factories through private frequencies (for example, frequencies in the 4.72 GHz and 28.9 GHz bands in Korea) have been introduced.

The specialized network may be built with small cells including femtocells, but in the description, it is assumed that the specialized network is built with femtocells. The femtocells may overlap with macrocells built for public network services, but in some cases, the femtocells may not overlap with the macrocells. In the description, a base station built for specialized network services may simply be referred to as a femtocell base station.

When the specialized network is built using the TDD method, the specialized network should be synchronized with neighboring TDD devices. A CU-DU-RU all-in one base station may be installed in the femtocell, and individually acquire the synchronization information by installing the GPS receiver at each base station, but is not suitable for the femtocell in terms of being built in a place where the GPS may not be received. Similar to the macrocell described in FIG. 2, the femtocell base stations may be synchronized by separately configuring the grand master node that provides the synchronization signals for multiple femtocells. However, in order to use the IEEE 1588 PTP-based synchronization method, the grand master node and the slave node should be connected within 5 hops to ensure the synchronization accuracy, so the grand master node should be installed close to the specialized network, which may increase investment costs. Therefore, instead of installing a separate grand master node for synchronization of the specialized network, the present disclosure will describe in detail a synchronization method in which the femtocell base station of the specialized network detects the synchronization information by analyzing signals from neighboring base stations.

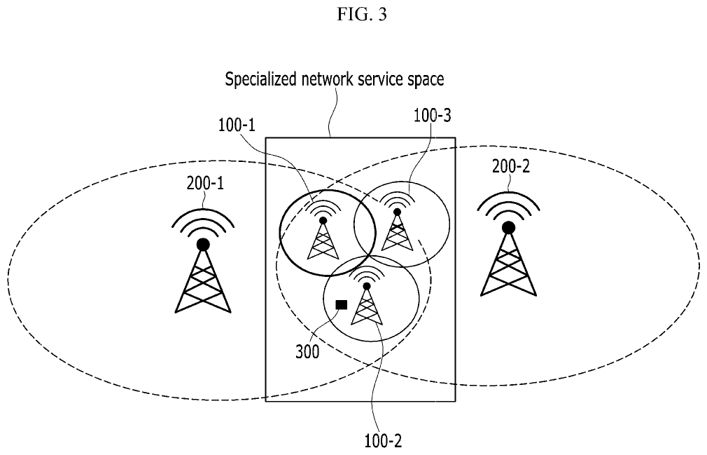

FIG. 3 is an exemplary diagram for describing an environment in which a femtocell base station is built for specialized network services according to an embodiment of the present disclosure.

Referring to FIG. 3, it is assumed that a specialized network service that provides communication services on a private frequency only in a certain space is provided. Here, the certain space may be called the specialized network service space, and may be specified as, for example, a building, a facility, a location, and the like.

At least one femtocell is built in the specialized network service space, and a femtocell base station 100 is installed in each femtocell to provide the specialized network services to the connected terminal 300. Here, the types of terminal 300 may vary. A plurality of femtocell base stations 100 (100-1, 100-2, and 100-3) may be installed in the specialized network service space.

The specialized network may be built based on the 5th generation (5G) communication system, but does not need to be limited thereto. In addition, the specialized network uses private frequencies that are different from those used in a public network. For example, the public network may use a frequency in the 3.5 GHz band, and the specialized network may use a frequency in the 4.7 GHz band, which may vary depending on frequency allocation in each country.

In the specialized network service space, not only femtocells for specialized network services but also macrocells may overlap. For example, macrocell base stations 200 (200-1 and 200-2) using the 3.5 GHz band are installed in the macrocells to provide communication services to the connected terminal.

The femtocell base station 100 needs to detect the synchronization information to use the TDD radio frame. The femtocell base station 100 may detect the synchronization information by analyzing signals from neighboring base stations, instead of using a separate grand master node. The femtocell base station 100 may provide the TDD radio frame in which the DL/UL section is switched according to the synchronization information. The synchronization information may further include start timing of the TDD radio frame and may further include TDD configuration. The TDD configuration may include a length and period of the DL/UL section required for the DL/UL switching.

The femtocell base station 100 is the CU-DU-RU all-in one base station and may include a synchronization detection module along with the CU, DU, and RU for the communication services. The synchronization detection module may be integrally manufactured with the CU, DU, and RU, or may be manufactured in a form that can be linked with the CU-DU-RU all-in one base station.

The synchronization detection module may include components for implementing the synchronization method according to the present disclosure. For example, the synchronization detection module may include a heterogeneous antenna module (e.g., 3.5 GHz and 4.7 GHz antennas) for receiving signals in a public frequency band and a private frequency band, a signal conversion module that converts an analog signal received through an antenna into a digital signal, a signal analysis module that analyzes the received signal to detect synchronization information, and a synchronization signal output module that generates a TDD synchronization signal according to the synchronization information. By the TDD synchronization signal, the femtocell base station 100 may provide TDD radio frames that are synchronized to neighboring TDD radio frames. The TDD synchronization signal may be a system clock signal synchronized to the clock of the reference base station, or a signal that synchronizes a system clock to the clock of the reference base station.

For the TDD radio frame synchronization, the start timing of the TDD radio frame is required. For the TDD radio frame synchronization, the femtocell base station 100 may scan signals transmitted from the neighboring macrocell base stations 200-1 and 200-2, and determine one macrocell base station 200-1 as the reference base station. In this case, the femtocell base station 100 may determine the base station that has transmitted a signal having the greatest power, that is, the closest base station, as the reference base station. Here, the signal power may be reference signal received power (RSRP).

The femtocell base station 100 may analyze a primary synchronization signal (PSS) and a secondary synchronization signal (SSS) included in the signal transmitted from the reference base station 200-1 to extract a synchronization signal block (SSB) index. The femtocell base station 100 may detect the start timing of the TDD radio frame based on the SSB index.

In this case, since there is a delay time depending on the distance between the reference base station 200-1 and the femtocell base station 100, the femtocell base station 100 may estimate the distance based on the signal power and reflect the delay time corresponding to the distance, thereby finely adjusting the start timing extracted based on the SSB index. In this case, the distance from the reference base station 200-1 is calculated considering the attenuation of the reference signal. It is assumed that the femtocell base station 100 does not know transmitted power Prx at which the reference base station 200-1 has transmitted the reference signal. Then, the femtocell base station 100 may temporarily calculate the distance under the assumption that the transmitted power of the reference signal is random power (for example, 18 dBm), and then detect the transmitted power of the reference signal in the SIB2 message transmitted from the reference base station 200-1, thereby calculating the accurate distance. For example, a distance d between the femtocell base station 100 and the reference base station 200-1 may be calculated as in Equation 1, and the delay time t corresponding to the distance may be calculated as in Equation 2. In Equation 1, Prx is the transmitted power of the reference signal, and the RSRP is the received power of the reference signal.

$$d = 10 * \frac{( {P}_{TX} - RSRP ) - 43.33}{20} \qquad ( Equation 1 )$$

$$t = \frac{d}{3 * {10}^{8}} \qquad ( Equation 2 )$$

In this way, the femtocell base station 100 may analyze signals from neighboring macrocell base stations to acquire the synchronization information of the TDD radio frame. Since the femtocell base station 100 uses a different frequency band from the macrocell base station, the signal from the macrocell base station may be received and used to detect the synchronization information without the need to stop communication services to detect the synchronization information.

Meanwhile, even if there is no macrocell base station nearby, the femtocell base station 100 may determine the already built neighboring femtocell base stations as the reference base station and analyze the signal from the reference base station to acquire the synchronization information.

The femtocell base station 100 may analyze the signal from the reference base station to set the start timing, and, if necessary, may detect the TDD configuration of the reference base station to configure the radio frame with the same TDD configuration as the reference base station or configure the radio frame with a different TDD from the reference base station. The femtocell base station 100 may decode the system information block (SIB) to acquire the length and period of the DL/UL section of the radio frame.

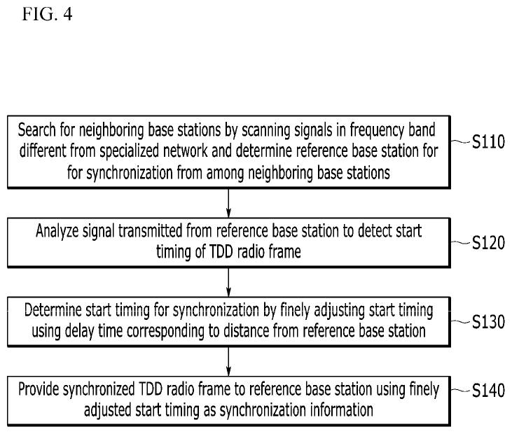

FIG. 4 is a flowchart of a synchronization method of a femtocell base station for a specialized network service according to an embodiment of the present disclosure.

Referring to FIG. 4, the femtocell base station 100 may scan signals in a different frequency band from the specialized network to search for neighboring base stations and determine a reference base station for synchronization from among the neighboring base stations (S110). For example, the femtocell base station 100 may scan signals transmitted from macrocells built by communication service providers to determine one macrocell base station as a reference base station. In this case, the femtocell base station 100 may be determined as a reference base station based on signal power, and the signal power may be reference signal received power (RSRP).

The femtocell base station 100 analyzes the signal transmitted from the reference base station to detect the start timing of the TDD radio frame (S120). The femtocell base station 100 may analyze the PSS and SSS included in the SS/PBCH block, extract the SSB index, and detect the start timing of the radio frame based on the SSB index.

The femtocell base station 100 uses the delay time corresponding to the distance from the reference base station to finely adjust the start timing, thereby determining the start timing for synchronization (S130). The femtocell base station 100 may estimate the distance based on the transmitted power and received power of the reference signal as shown in Equation 1, and use the delay time corresponding to the distance to finely adjust the start timing of the wireless frame detected based on the SSB index. Before the transmitted power of the reference signal required for distance estimation is detected, the femtocell base station 100 may temporarily calculate the distance under the assumption that the transmitted power of the reference signal is the random power (for example, 18 dBm). Thereafter, when the transmitted power of the reference signal is detected, the femtocell base station 100 may accurately estimate the distance based on the transmitted power and received power of the reference signal to calculate the delay time, and use the calculated delay time to readjust the start timing.

The femtocell base station 100 uses the finely adjusted start timing as the synchronization information to provide the synchronized TDD radio frame to the reference base station (S140). The femtocell base station 100 provides specialized network services using TDD radio frames synchronized to neighboring base stations.

In this way, the femtocell base station 100 may receive a signal in a frequency band different from the specialized network to acquire the synchronization information, so there is no need to stop the specialized network service using the private frequency to receive the synchronization signal.

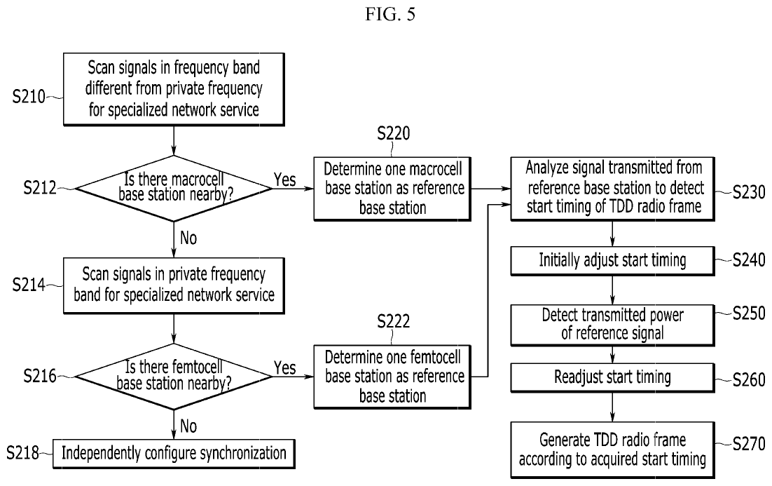

FIG. 5 is a flowchart of a synchronization method of a femtocell base station for a specialized network service according to embodiments of the present disclosure.

Referring to FIG. 5, when the femtocell base stations 100-1 and 100-2 are installed for specialized network services and the femtocell base station 100-3 is newly installed, the synchronization method of the new femtocell base station 100-3 will be described. For example, it is assumed that the femtocell base station 100-3 uses a private frequency in the 4.7 GHz band, and the macrocell base station uses a public frequency in the 3.5 GHz band, but the allocated frequencies may be changed.

The femtocell base station 100-3 scans signals in a frequency band (e.g., 3.5 GHz) different from the private frequency for specialized network services (S210) to search for whether there is a macrocell base station nearby (S212).

When at least one macrocell base station is searched, the femtocell base station 100-3 determines one macrocell base station as the reference base station (S220). The femtocell base station 100-3 may be determined as the base station that has transmitted a signal having the greatest power, that is, the closest base station, as the reference base station.

When there is no macrocell base station, the femtocell base station 100-3 scans signals in a private frequency band (e.g., 4.7 GHz) for specialized network services (S214) to search for whether there is a femtocell base station of a specialized network nearby (S216).

When at least one macrocell base station is searched, the femtocell base station 100-3 determines one macrocell base station as the reference base station (S222).

When there is no femtocell base station nearby that may acquire the synchronization information, the femtocell base station 100-3 independently configures synchronization (S218). After independently configuring the synchronization, the femtocell base station 100-3 may periodically move to a step (S210) of searching for neighboring macrocell base stations to attempt to detect the synchronization information.

After the reference base station for synchronization is determined, the femtocell base station 100-3 analyzes the signal transmitted from the reference base station to detect the start timing of the TDD radio frame (S230). The femtocell base station 100 may analyze the PSS and SSS included in the SS/PBCH block, extract the SSB index, and detect the start timing of the radio frame based on the SSB index.

The femtocell base station 100-3 initially adjusts the detected start timing using the delay time corresponding to the distance from the reference base station (S240). The distance from the reference base station is calculated by considering attenuation of the reference signal, and it may take time for the femtocell base station 100-3 to detect the transmitted power of the reference signal transmitted from the reference base station. Accordingly, the femtocell base station 100-3 may assume the transmitted power of the reference signal to be random power (for example, 18 dBm), temporarily calculate the distance, and then initially adjust the start timing.

Thereafter, the femtocell base station 100-3 analyzes the signal transmitted from the reference base station to detect the transmitted power of the reference signal (S250). After acquiring all downlink/uplink information of the reference base station, the femtocell base station 100-3 may decode an SIB 2 message transmitted from the reference base station to detect the transmitted power of the reference signal.

The femtocell base station 100-3 readjusts the start timing using the delay time calculated based on the difference between the transmitted power and the received power of the reference signal (S260). The femtocell base station 100-3 may finely adjust the start timing of the TDD radio frame using the accurate transmitted power of the reference signal. In this case, the femtocell base station 100-3 may manage the number N of times that the start timing is finely adjusted and may limit the time of number of fine adjustment to the certain number of times (for example, N=2). Here, it is assumed that the number N of times that the start timing is finely adjusted is initially set to 0. The synchronization accuracy may increase by repeating the fine adjustment procedure up to the reference number of times. When the fine adjustment procedure is completed up to the standard number of times, the start timing adjustment procedure may be skipped. When the reference base station does not change, the transmitted power of the reference signal is the same, so the start timing adjustment procedure may be skipped.

The femtocell base station 100-3 generates the TDD radio frame according to the acquired start timing (S270). The TDD configuration (length of the DL/UL section, period, etc.) of the TDD radio frame may be fixed or arbitrarily determined regardless of neighboring signals, or may be adaptively determined according to the TDD configuration of neighboring signals.

Meanwhile, when the femtocell base station 100-3 determines that neighboring femtocell base stations using the same frequency band are the reference base station, it may determine whether the reference base station belongs to the same group as itself. Before readjusting the start timing of the radio frame, the femtocell base station 100-3 may determine whether the reference base station is a femtocell base station belonging to the same group.

The femtocell base station 100-3 may decode the SIB 1 message transmitted from the reference base station to detect a femtocell group identifier (e.g., PCI and eCGI, etc.), and when the reference base station is the same group as itself, may its own TDD wireless frame identical to the TDD configurations (length and period of DL/UL section, etc.) of the reference base station. On the other hand, when the reference femtocell base station belongs to a different group from itself, the femtocell base station 100-3 may configure its own TDD radio frame differently from the TDD configuration of the reference base station.

For example, when operator A provides a specialized network service that uses DL more than UL, a TDD configuration with a DL/UL section ratio of 4:1 may be used, and when operator B provides a specialized network service that uses a lot of ULs, such as CCTV, a TDD configuration with a DL/UL section ratio of 1:1 may be used. Therefore, a newly installed femtocell base station may set the TDD configurations extracted from the signal from the reference base station belonging to the same group to its own TDD radio frame. In this way, base stations providing the same service, that is, base stations in the same group, use radio frames with the same TDD configurations. Naturally, a newly installed femtocell base station may know in advance the TDD configurations to be used for specialized services, and when it is confirmed that the reference base station is in the same group, the radio frame may be configured using the TDD configurations of the group. On the other hand, when the reference base station belongs to a different group, the newly installed femtocell base station may detect the TDD configuration of the reference base station and use a different TDD configuration to minimize interference with neighboring femtocell base stations.

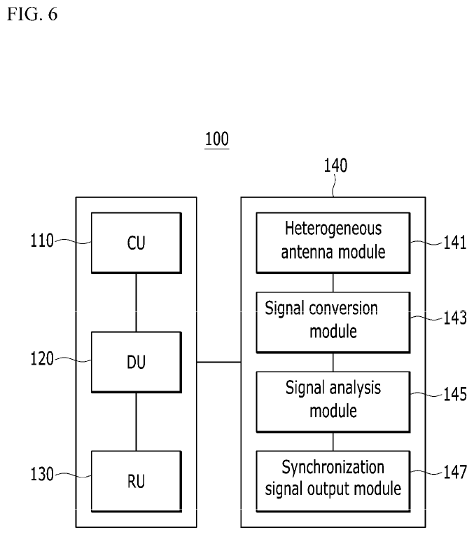

FIG. 6 is a schematic diagram of a femtocell base station for a specialized network service according to an embodiment of the present disclosure.

Referring to FIG. 6, the femtocell base station 100 may include a central unit (CU) 110, a digital unit (DU) 120, a radio unit (RU) 130, and a synchronization detection module 140. Here, the CU, DU, RU, and synchronization detection modules are divided to describe their functions and do not necessarily need to be physically separated. The synchronization detection module 140 may be integrally manufactured with the CU 110, the DU 120, and RU 130, or may be manufactured in a form that can be linked with the CU-DU-RU all-in one base station. Here, the CU, DU, and RU provide general functions of the base station, and therefore, detailed descriptions thereof will be omitted.

The synchronization detection module 140 may search for neighboring base stations by scanning signals in a different frequency band from the frequency allocated for the specialized network, and determine a reference base station for detecting synchronization information from among the neighboring base stations. The synchronization detection module 140 may analyze the signal transmitted from the reference base station to detect the start timing of the TDD radio frame, and then use the delay time corresponding to the distance from the reference base station to finely adjust the start timing, thereby acquiring the synchronization information. The synchronization detection module 140 may estimate the distance from the reference base station based on transmitted power and received power of the reference signal transmitted from the reference base station, and finely adjust the start timing using the delay time corresponding to the distance. When neighboring base stations using a public frequency are not searched, the synchronization detection module 140 may search for new neighboring base stations by scanning signals of a private frequency and determine a reference base station from among the new neighboring base stations.

The synchronization detection module 140 may include a heterogeneous antenna module 141 (e.g., 3.5 GHz and 4.7 GHz antennas) for receiving signals in a public frequency band and a private frequency band, a signal conversion module 143 that converts an analog signal received through an antenna into a digital signal, a signal analysis module 145 that analyzes the received signal to detect synchronization information, and a synchronization signal output module 147 that generates a TDD synchronization signal according to the synchronization information. The component modules of the synchronization detection module 140 are divided to describe functions, and do not necessarily need to be physically separated.

By the TDD synchronization signal, the RU 130 may provide TDD radio frames that are synchronized to neighboring TDD radio frames.

The femtocell base station 100 may include hardware such as at least one processor, memory, and storage device that executes instructions described to execute the operations of the present disclosure, and the types of processors may vary.

As described above, it is possible for a femtocell base station built for a specialized network service to analyze signals from neighboring base stations and acquire synchronization information without the need to build a separate grand master node for the specialized network.

According to the present disclosure, it is possible to increase synchronization accuracy by fine adjusting a start timing of a TDD radio frame using a delay time corresponding to a distance from a reference base station.

According to the present disclosure, even if a femtocell base station built for a specialized network service does not discover a macrocell base station using a public frequency, it is possible to obtain synchronization information by analyzing signals from neighboring femtocell base stations using a private frequency.

Although embodiments of the present disclosure have been described in detail hereinabove, the scope of the present disclosure is not limited thereto, but may include several modifications and alterations made by those skilled in the art using a basic concept of the present disclosure as defined in the claims.

What is claimed is:

1. A synchronization method of a femtocell base station built in a specialized network, comprising:
searching for at least one neighboring base station by scanning signals in a second frequency band different from a first frequency band allocated for the specialized network;
determining a reference base station for synchronization from among the at least one neighboring base station;
analyzing a signal transmitted from the reference base station to detect start timing of a time division duplex (TDD) radio frame; and
finely adjusting the start timing using a delay time corresponding to a distance from the reference base station.

2. The synchronization method of claim 1, wherein the determining the reference base station comprises
determining the reference base station from among the at least one neighboring base station based on reference signal received power.

3. The synchronization method of claim 1, wherein the finely adjusting the start timing comprises
estimating the distance from the reference base station based on transmitted power and received power of the reference signal transmitted from the reference base station, and finely adjusting the start timing using the delay time corresponding to the distance.

4. The synchronization method of claim 3, wherein the finely adjusting the start timing comprises:
initially adjusting the start timing based on random transmitted power and the received power, when the transmitted power of the reference signal is not detected; and
readjusting the start timing based on the detected transmitted power and received power, when the transmitted power of the reference signal is detected.

5. The synchronization method of claim 1, further comprising:
providing the specialized network service using the TDD radio frame synchronized to the reference base station by the finely adjusted start timing.

6. The synchronization method of claim 1, wherein the reference base station includes a macrocell base station that provides a communication service in the second frequency band.

7. The synchronization method of claim 1, further comprising:
when the neighboring base station is not searched through the scanning in the second frequency band, searching for at least one new neighboring base station by scanning the signals in the first frequency band and determining the reference base station from among the at least one new neighboring base station.

8. The synchronization method of claim 7, further comprising:
when the reference base station is searched in the first frequency band, determining whether the reference base station belongs to the same group to use the same TDD configuration as the reference base station or use a TDD configuration different from the reference base station.

9. The synchronization method of claim 1, wherein the femtocell base station is an all-in one base station including a central unit (CU), a digital unit (DU), and a radio unit (RU).

10. A synchronization method of a femtocell base station built in a specialized network, comprising:
determining a reference base station for synchronization from among the searched neighboring base stations;
analyzing a signal transmitted from the reference base station to determine start timing of a TDD radio frame; and
providing the specialized network service using the TDD radio frame synchronized to the reference base station by the determined start timing.

11. The synchronization method of claim 10, wherein the determining the reference base station comprises
determining the reference base station from among the at least one neighboring base station based on reference signal received power.

12. The synchronization method of claim 10, wherein the reference base station includes a neighboring macrocell base station that provides a communication service using a second frequency different from a first frequency allocated for the specialized network, or a neighboring femtocell base station that provides a specialized network service using the first frequency.

13. The synchronization method of claim 12, further comprising:
when the reference base station is the neighboring femtocell base station, determining whether the reference base station belongs to the same group;
when the reference base station belongs to the same group, configuring a TDD radio frame with the same TDD configuration as the reference base station; and
when the reference base station belongs to a different group, configuring a TDD radio frame with a TDD configuration different from the reference base station.

14. The synchronization method of claim 10, wherein the determining the start timing comprises:
analyzing a signal transmitted from the reference base station to detect the start timing, and
estimating the distance from the reference base station based on transmitted power and received power of the reference signal transmitted from the reference base station, and finely adjusting the start timing using the delay time corresponding to the distance.

15. The synchronization method of claim 14, wherein the finely adjusting the start timing comprises:
initially adjusting the start timing based on random transmitted power and the received power, when the transmitted power of the reference signal is not detected: and
readjusting the start timing based on the detected transmitted power and received power, when the transmitted power of the reference signal is detected.

16. The synchronization method of claim 10, wherein the femtocell base station is an all-in one base station including a central unit (CU), a digital unit (DU), and a radio unit (RU).

17. A femtocell base station for a specialized network, comprising:
a central unit (CU), a digital unit (DU), a radio unit (RU), and synchronization detection module,
wherein the synchronization detection module is configured to
search for at least one neighboring base station by scanning signals in a second frequency band different from a first frequency band allocated for the specialized network,
determine a reference base station for synchronization from among the at least one neighboring base station,
detect start timing of a time division duplex (TDD) radio frame by analyzing a signal transmitted from the reference base station, and
acquire synchronization information by finely adjusting the start timing using a delay time corresponding to a distance from the reference base station.

18. The femtocell base station of claim 17, wherein the synchronization detection module is configured to estimate the distance from the reference base station based on transmitted power and received power of the reference signal transmitted from the reference base station, and finely adjust the start timing using the delay time corresponding to the distance.

19. The femtocell base station of claim 17, wherein the synchronization detection module is configured to search for at least one new neighboring base station by scanning the signals in the first frequency band and determine the reference base station from among the at least one new neighboring base station, when the neighboring base station is not searched through the scanning in the second frequency band.

20. The femtocell base station of claim 19, wherein the synchronization detection module is configured to determine whether the reference base station belongs to the same group to use the same TDD configuration as the reference base station or use a TDD configuration different from the reference base station, when the reference base station is searched in the first frequency band.
